(19) United States
(12) Patent Application Publication
(10) Pub. No.: US 2026/0346142 A1
(43) Pub. Date: Nov. 5, 2026

(54) VIRTUAL MAP MARKING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventor: Jieqi XIE, Shenzhen (CN)

(21) Appl. No.: 19/718,609

(22) Filed: Jun. 24, 2026

Related U.S. Application Data
(63) Continuation of application No. PCT/CN2025/085581, filed on Mar. 28, 2025.

(30) Foreign Application Priority Data
May 16, 2024 (CN) 202410631750.2

(51) Int. Cl. A63F 13/5378; G06F 3/04845; G06F 9/451

(52) U.S. Cl. CPC A63F 13/5378; G06F 3/04845; G06F 9/451

(57) ABSTRACT

This application discloses a virtual map marking method performed by a computer device and relates to the field of human-computer interaction. The method includes: displaying a graphical user interface of a battle including a virtual scene and a virtual map, the virtual map being configured for describing terrain information of the virtual scene; in response to receiving a point trigger operation on a first point in the virtual map, dynamically generating a first range identifier in the virtual map using the triggered first point, wherein a partial region including a position indicated by the first point on the virtual map is marked in the first range identifier; and displaying the first range identifier on the virtual map. A range identifier displayed on the virtual map provides more battle information for players, to improve efficiency of transferring battle information between the players.

### CROSS-REFERENCE TO RELATED APPLICATIONS

This application is a continuation application of PCT Patent Application No. PCT/CN2025/085581, entitled “VIRTUAL MAP MARKING METHOD AND APPARATUS, DEVICE, STORAGE MEDIUM, AND PROGRAM PRODUCT” filed on Mar. 28, 2025, which claims priority to Chinese Patent Application No. 202410631750.2, entitled “VIRTUAL MAP MARKING METHOD AND APPARATUS, DEVICE, STORAGE MEDIUM, AND PROGRAM PRODUCT” filed with the China National Intellectual Property Administration on May 16, 2024, both of which are incorporated by reference in their entirety.

### FIELD OF THE TECHNOLOGY

The present disclosure relates to the field of human-computer interaction, and more specifically, to a virtual map marking method.

### BACKGROUND OF THE DISCLOSURE

In an application program supporting a virtual scene, a player may be in battle communication with another player by marking a virtual place.

In a related technology, a terminal receives a marking operation performed by the player on any point on a virtual map, generates a mark corresponding to the point, and forms a connection line between a current position of the player and the point. The connection line is configured for prompting the player to head to a marked point along a path indicated by the connection line.

However, the manner used in the related technology reduces efficiency of transferring battle information between players.

### SUMMARY

The embodiments of this application provide a virtual map marking method and apparatus, a device, a storage medium, and a program product. This can effectively improve the efficiency of transferring battle information between players. The technical solutions are as follows:

According to one aspect, a virtual map marking method is performed by a computer device. The method includes:
displaying a graphical user interface of a battle including a virtual scene and a virtual map, the virtual map being configured for describing terrain information of the virtual scene;
in response to receiving a point trigger operation on a first point in the virtual map, dynamically generating a first range identifier in the virtual map using the triggered first point, wherein a partial region including a position indicated by the first point on the virtual map is marked in the first range identifier; and
displaying the first range identifier on the virtual map.

According to another aspect, a computer device is provided, the computer device including a processor and a memory, the memory storing at least one instruction, at least one program, and a code set or an instruction set, and the at least one instruction, the at least one program, the code set or the instruction set being loaded and executed by the processor to implement the virtual map marking method according to any one of the embodiments of this application.

According to another aspect, a non-transitory computer-readable storage medium is provided, the computer-readable storage medium storing at least one program, and the at least one program, when loaded and executed by a processor of a computer device, causing the computer device to implement the virtual map marking method according to any one of the embodiments of this application.

Beneficial effects of the technical solutions provided in the embodiments of this application at least include:

In this application, a range marking function is provided for a player, that is, the first range marking operation is performed on partial regions on the virtual map, to generate a first range identifier identifying the partial regions. Therefore, compared with the related technology in which only a single point is marked, the player may mark partial regions on the virtual map, and marks on partial regions belong to a range mark. More information in a battle may be transferred through one marking operation, to improve the efficiency of transferring the battle information. For example, when the player is in a special scene, the battle information is directly transferred through the range mark, so that the efficiency of transferring the battle information between players may be improved, thereby improving the battle experience. For example, when virtual resources placed in different regions in the virtual scene are imbalanced, the player may perform the range mark on a high resource area (an area including more virtual resources or virtual organs) on the virtual map, and a generated first range identifier may provide more battle information for the player, so that the player intuitively knows a range of the high resource area by using the first range identifier, thereby improving the player's ability to sense battle resources.

### BRIEF DESCRIPTION OF THE DRAWINGS

FIG. 1 is a schematic diagram of an interface of a virtual map marking method according to an embodiment.

FIG. 2 is a schematic diagram of a computer system according to an embodiment.

FIG. 3 is a flowchart of a virtual map marking method according to an embodiment of this application.

FIG. 4 is a schematic diagram of enlarging a first range identifier from a minimum range to a maximum range according to an embodiment of this application.

FIG. 5 is a schematic diagram of generating a first range identifier based on a sliding operation according to an embodiment of this application.

FIG. 6 is a flowchart of a virtual map marking method according to another embodiment of this application.

FIG. 7 is a schematic diagram of establishing a coordinate system for a first range identifier corresponding to a first point according to an embodiment of this application.

FIG. 8 is a schematic diagram of dynamically adjusting a first range identifier according to a tilt operation according to an embodiment of this application.

FIG. 9 is a flowchart of a virtual map marking method according to still another embodiment of this application.

FIG. 10 is a schematic diagram of an interface of performing range marking on a virtual map again according to an embodiment of this application.

FIG. 11 is a flowchart of a virtual map marking method according to yet another embodiment of this application.

FIG. 12 is a flowchart of a virtual map marking method according to yet another embodiment of this application.

FIG. 13 is a flowchart of a virtual map marking method according to yet another embodiment of this application.

FIG. 14 is a structural block diagram of a virtual map marking apparatus according to another embodiment of this application.

FIG. 15 is a structural block diagram of a computer device according to an embodiment of this application.

### DESCRIPTION OF EMBODIMENTS

To make objectives, technical solutions, and advantages of this application more comprehensible, the following further describes implementation manners of this application in detail with reference to the accompanying drawings. The described embodiments are a part rather than all of the embodiments of this application. All other embodiments acquired by a person of ordinary skill in the art based on the embodiments of this application without creative efforts shall fall within the protection scope of this application.

In this application, terms such as “first” and “second” are configured for distinguishing same items or similar items having same functions. The “first” and the “second” do not have a logical or time sequence dependency relationship, and do not limit a quantity and an execution sequence.

First, terms involved in the embodiments of this application are briefly described.

Virtual scene: The virtual scene includes a scene displayed when a target application program is run on a terminal, for example, a game scene displayed when a shooting game is run on the terminal. The virtual scene includes at least one of a two-dimensional virtual scene, a 2.5-dimensional virtual scene, a three-dimensional virtual scene, and the like. This is not limited in the embodiments of this application. The virtual scene may be a completely fictional scene, a simulated scene of the real world, or a semi-simulated and semi-fictional scene. In the embodiments of this application, the virtual scene includes at least one point, and the point is configured for indicating a position in the virtual scene.

Virtual object: The virtual object is a movable object in the virtual scene. The movable object may be a virtual person, a virtual animal, an animation person, or the like, for example, a person, an animal, a plant, an oil barrel, a wall, or a stone displayed in the virtual scene. In some embodiments, when the virtual scene is implemented as the three-dimensional virtual scene, the virtual object is a three-dimensional model created based on an animation skeleton technology. Each virtual object has a shape and a volume in the three-dimensional virtual environment, and occupies a part of space in the three-dimensional virtual environment.

Virtual map: The virtual map is configured for describing terrain information of a virtual scene in a battle. In a virtual game battle, different virtual blocks included in the virtual scene are described by using symbols, colors, text, and the like according to a first ratio. For example, a virtual building, a virtual item, a virtual vehicle, a virtual organ, and a virtual land are identified by using different symbols, colors, or text, to form the virtual map for describing the virtual scene in the battle. In some embodiments, the virtual map includes a global virtual map and a thumbnail virtual map. The global virtual map is configured for completely displaying terrain information of the virtual scene in the battle, and the thumbnail virtual map is configured for displaying terrain information within a preset range centered on the virtual object.

Virtual organ: The virtual organ is configured to interact with the virtual object in the virtual scene. For example, the virtual scene includes a virtual task organ, a virtual plot trigger organ, a virtual shop, and the like.

In an application program supporting the virtual scene, a player needs to perform point marking on the virtual map to implement battle communication with another player. For example, a player a marks a point 1 on the virtual map, and a terminal generates a connection line between the player a and the point 1 based on a point marking operation of the player a, and synchronizes the connection line to a terminal of another player in the same team with the player a. An objective of completing battle information exchange in a special case such as the player muting a microphone is implemented.

In a related technology, a player can mark only one point by performing one marking operation on a virtual map, and only one point identifier corresponding to the point can be displayed on the virtual map. In some special scenes such as a high resource region and multi-virtual organ point, more information cannot be transferred through marking of only one port. Players need to frequently mark points in the high resource region, which cannot effectively improve efficiency of transferring battle information between players and also increases operation procedures when the players perform battles.

However, in a virtual map marking method provided in this application, when performing a marking operation on a virtual map, a player can perform range marking on a partial region on the virtual map by using one marking operation, so that a problem of marking only one point at a time is resolved, and an operation requirement of a plurality of points within a marked range is implemented, thereby improving the efficiency of transferring battle information between players in a special case such as a player muting a microphone.

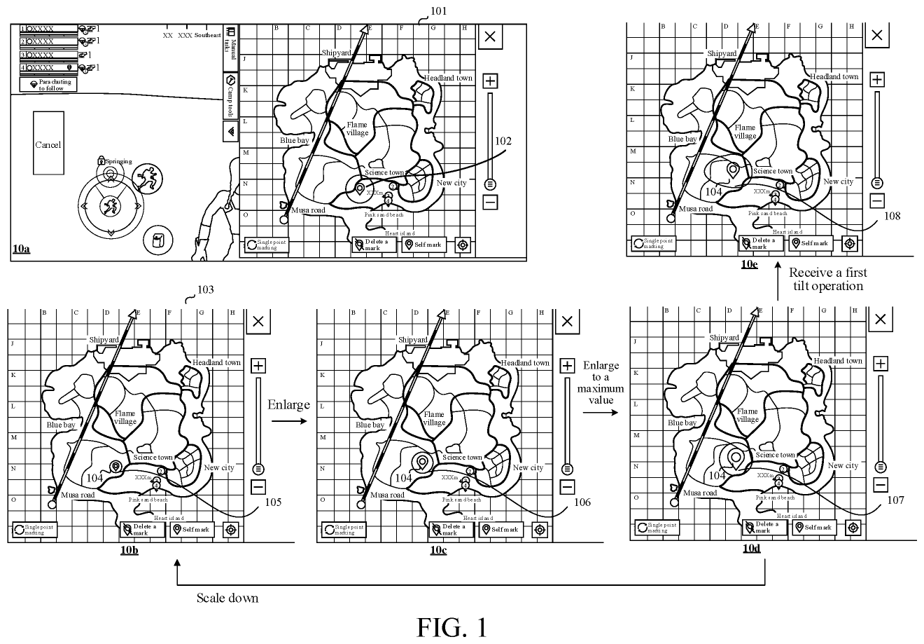

FIG. 1 is a schematic diagram of a virtual position marking method according to an embodiment of this application.

In this application, a target application program supporting a virtual scene is installed and run on a terminal held by a player. The target application program may be any one of a virtual reality application program, a first-person shooting (FPS) game, a third-person shooting (TPS) game, a multiplayer online battle arena game (MOBA), a massive multiplayer online role-playing game (MMORPG), and the like. This is not limited in the embodiments of this application.

The terminal displays the virtual scene through the target application program. The virtual scene includes a virtual map and a virtual object. The target application program provides a function of marking a point and a range in the virtual map.

As shown in 10a in FIG. 1, a virtual map 101 is displayed on a display interface. A first range identifier 102 is generated in response to receiving a first range marking operation on the virtual map 101, and the first range identifier 102 is displayed on the virtual map 101.

In another embodiment, as shown in 10b in FIG. 1, in response to receiving a first range marking operation on a first point 104 on a virtual map 103, a minimum marked range (for example, a marked region 105 shown in 10b in FIG. 1) of the first range identifier is displayed at a position shown by the first point 104; in response to a continuous trigger operation on the first point 104, as time proceeds, the minimum marked range of the first range identifier is dynamically enlarged (a region obtained through enlarging is, for example, a marked region 106 shown in 10c in FIG. 1) until a region marked by the first range identifier is enlarged to a maximum value (for example, a marked region 107 shown in 10d in FIG. 1); in response to the continuous trigger operation on the first point 104, as time proceeds, after the region marked by using the first range identifier is enlarged to the maximum value, a marked range of the first range identifier is dynamically scaled down to the minimum marked range, where the minimum marked range is consistent with the marked region 105 shown in 10b in FIG. 1; and the marked range of the first range identifier is cyclically and dynamically scaled when the continuous trigger operation on the first point 104 is not canceled.

In another embodiment, in a process of performing the continuous trigger operation on the first point 104, if a tilt operation on a terminal body (namely, a body of the terminal) is received, the marked range of the first range identifier is adjusted based on a direction to which the tilt operation points. When the marked range of the first range identifier is shown in 10d in FIG. 1, in response to receiving a first tilt operation on the terminal body in a counter-clockwise rolling direction, to cause a right side of the terminal body to be higher than a left side of the terminal body, a left region of the marked range 107 shown in 10d in FIG. 1 is extended outward, to generate a marked range 108 of the first range identifier shown in 10e in FIG. 1.

In the foregoing solution, a function of performing range marking on a virtual map is provided for a player. During range marking, a marked range of a generated range identifier is dynamically changed on the virtual map, so that the player can more intuitively feel a process of generating the range identifier, to improve interest of the player in performing range marking and prevent the player from performing an unnecessary marking process, and improve human-computer interaction efficiency. In addition, a manner of generating a range identifier with an irregular marked range according to a tilt angle of a terminal body is further provided, to provide more diversified and free selection for a range identifier generation manner.

The terminal may be a smartphone, a tablet computer, a desktop computer, a portable notebook computer, a smart appliance, a vehicle-mounted terminal, an aircraft, or the like, but is not limited thereto.

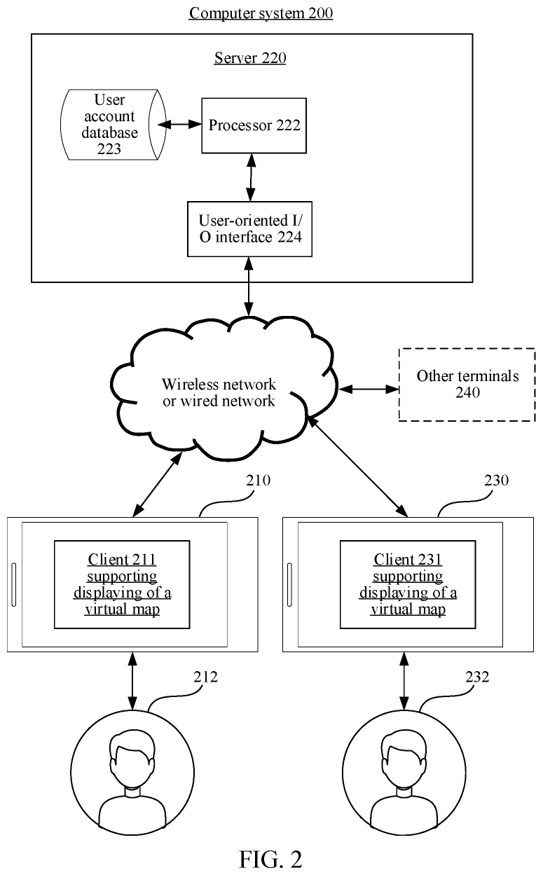

FIG. 2 is a structural block diagram of a computer system according to an embodiment of this application. A computer system 200 includes: a first terminal 210, a server 220, and a second terminal 230.

A client 211 supporting displaying of a virtual map interface is installed and run on the first terminal 210. The client 211 may be a game program. When the first terminal 210 runs the client 211, a battle interface of the client 211 is displayed on a screen of the first terminal 210. The first terminal 210 is a terminal used by a first user 212. A first account is logged into on the first terminal 210.

A client 231 supporting displaying the virtual map interface is installed and run on the second terminal 230. The client 231 may be a game program. When the second terminal 230 runs the client 231, a battle interface of the client 231 is displayed on a screen of the second terminal 230. The second terminal 230 is a terminal used by a second user 232. A second account is logged into on the second terminal 230.

In some embodiments, the first user 212 and the second user 232 are users in the same camp.

In some embodiments, clients installed on the first terminal 210 and the second terminal 230 are the same, or clients installed on the two terminals are clients of the same type on different operating system platforms (Android or IOS). The first terminal 210 may be one of a plurality of terminals, and the second terminal 230 may be another one of the plurality of terminals. In this embodiment, only the first terminal 210 and the second terminal 230 are used as an example for description. Device types of the first terminal 210 and the second terminal 230 are the same or different, and the device type includes: at least one of a smartphone, a wearable device, a smart television, a vehicle-mounted terminal, a tablet computer, an e-book reader, an MP3 player, an MP4 player, a laptop portable computer, and a desktop computer. In the following embodiment, that a terminal is the smartphone is used as an example for description.

In some embodiments, when the first user 212 performs range marking on a virtual map in the battle interface shown by the first terminal 210, the first terminal 210 generates a range identifier of the range marking operation, and displays the range identifier on the virtual map in the battle interface shown by the first terminal 210. The server 220 synchronizes the range marking operation and the range identifier, and displays the range identifier on a virtual map in the battle interface of the second terminal 230 corresponding to the second user 232. An objective of performing range marking in the same camp is implemented, and efficiency of transferring battle information between the first user 212 and the second user 232 is improved.

A person skilled in the art may know that there may be more or fewer terminals. For example, there may be only one terminal, or there may be six, eight, or more terminals. A quantity of terminals and device types are not limited in the embodiments of this application.

FIG. 2 only shows two terminals, but a plurality of other terminals 240 may access the server 220 in different embodiments. In some embodiments, one or more terminals 240 are further terminals corresponding to a developer. A development and editing platform of a client supporting displaying a virtual map interface is installed on the terminal 240. The developer may edit and update the client on the terminal 240, and transmit an updated client installation package to the server 220 through a wired or wireless network. The first terminal 210 and the second terminal 230 may download the client installation package from the server 220 to implement updating of the clients.

The first terminal 210, the second terminal 230, and the another terminal 240 are connected to the server 220 through a wireless network or a wired network.

The server 220 includes at least one of one server, a plurality of servers, a cloud computing platform, and a virtualization center. The server 220 is configured to provide a backend service for a client supporting a three-dimensional virtual environment. In some embodiments, the server 220 takes primary computing work, and the terminal takes secondary computing work. Alternatively, the server 220 takes secondary computing work and the terminal takes primary computing work. Alternatively, the server 220 and the terminal perform collaborative computing by using a distributed computing architecture.

In an exemplary example, the server 220 includes a processor 222, a user account database 223, and a user-oriented input/output interface (I/O interface) 224. The processor 222 is configured to load instructions stored in the server 220, and process data in the user account database 223. The user account database 223 is configured to store data of user accounts used by the first terminal 210, the second terminal 230, and the another terminal 240, such as a user account picture, a user account nickname, a battle effectiveness index of the user account, a service region in which the user account is located, an object owned by the user account, and a sharing relationship between the user account and another account. The user-oriented I/O interface 224 is configured to establish communication with the first terminal 210 and/or the second terminal 230 through a wireless network or a wired network to exchange data.

Information (including, but not limited to, user equipment information, user personal information, and the like), data (including, but not limited to, data for analysis, stored data, displayed data, and the like), and signals involved in this application are authorized by a user or are fully authorized by all parties, and collection, use, and processing of related data need to comply with related laws and regulations and standards of related countries and regions. For example, all player operation data involved in this application is obtained with sufficient authorization.

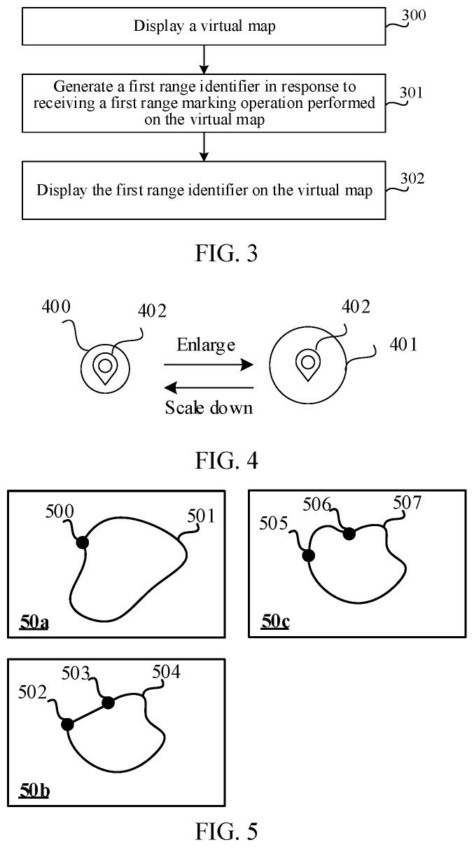

With reference to the foregoing descriptions, FIG. 3 is a flowchart of a virtual map marking method according to an embodiment of this application. The method is performed by a terminal, and the method includes the following operations.

Operation 300: Display a virtual map.

In some embodiments, the terminal displays a virtual scene through a target application program, and the virtual scene is established by relevant persons with reference to a virtual land, a virtual terrain, and a virtual block placed in the virtual land. To further enable a player to better understand global information of the virtual scene, a virtual map is drawn for the virtual scene. The virtual map is configured for describing terrain information of the virtual scene in a virtual battle. Different virtual resources on the virtual map are identified by using different symbols, colors, or text. For example, the virtual scene includes a virtual building, a virtual river, and a virtual transferring point. In the virtual map, the virtual building is marked by using a “house” identifier, the virtual river is marked by using a blue “river” identifier, and the virtual transferring point is marked by using a “kaleidoscope” identifier.

Display forms of the virtual map in the target application program include global display and partial display.

When the virtual map is displayed in a global display form in the target application program, the virtual map may be understood as a global virtual map, configured for displaying a complete virtual scene.

When the virtual map is displayed in a partial display form in the target application program, the virtual map may be understood as a thumbnail virtual map, configured for displaying a virtual scene within a preset range centered on a (main control) virtual object, or displaying a virtual scene with a preset range around the (main control) virtual object.

In this embodiment of this application, a global map control is displayed in the virtual scene. The global virtual map is displayed in the target application program in response to receiving a trigger operation on the global map control. A player may perform a point trigger operation on the global virtual map, mark a point, and transfer battle information to a teammate in the same team.

Operation 301: Generate a first range identifier in response to receiving a first range marking operation performed on the virtual map.

The first range marking operation is an operation of marking a partial region or an entire region on the virtual map. After receiving the first range marking operation, the terminal generates the first range identifier corresponding to the first range marking operation. In some embodiments, the first range marking operation includes any one of a click/tap operation, a double-click/tap operation, a long press operation, a voice operation, a peripheral instruction, a triple-click/tap operation, and the like.

In this application, a form of the first range identifier is not limited. In some embodiments, the form of the first range identifier includes a shape, a color, transparency, a frame, brightness, and the like of a marked range. In some embodiments, the first range identifier completely blocks the partial region on the virtual map. In some embodiments, the first range identifier is a transparent range identifier, and the partial region on the virtual map marked by the first range identifier is still displayed on an interface.

In an embodiment, several mark options are displayed on the virtual map. A first range identifier corresponding to a first mark option is generated in response to the first mark option being selected. The several mark options are distributed at several positions of the virtual map. Each of the several mark options corresponds to a respective range identifier.

In another embodiment, in response to receiving a trigger operation on any point on the virtual map, a first range identifier is statically generated based on a triggered first point. For example, in response to receiving a trigger operation on the first point, a first range identifier having a fixed size is superimposed at a position indicated by the first point, where the position indicated by the first point is marked in the first range identifier, and the first range identifier is a transparent range identifier.

In another embodiment, in response to receiving a continuous trigger operation on any point on the virtual map, the first range identifier is dynamically generated based on a continuous trigger operation on a first point. For example, in response to receiving a long press operation on the first point, a marked region of the first range identifier is dynamically enlarged in a process of performing the long press operation. For a specific process of dynamically generating the first range identifier, refer to the following four cases, which are merely an example for description herein.

Operation 302: Display the first range identifier on the virtual map.

In some embodiments, identifiers corresponding to various virtual resources are displayed on the virtual map. For example, a building identifier corresponding to a virtual building, a task identifier corresponding to a virtual task point, and a resource identifier corresponding to a virtual resource are displayed on the virtual map. All the identifiers displayed in a region marked by using the first range identifier are highlighted. In some embodiments, when all the identifiers displayed in the region marked by using the first range identifier are highlighted, virtual resource types corresponding to the identifiers included in the first range identifier are broadcasted. For example, the region marked by using the first range identifier includes three virtual buildings and two virtual resources. The terminal displays resource prompt information, where the resource prompt information is “There are three virtual buildings and two virtual resources in this marked range”. Alternatively, the terminal broadcasts resource prompt information.

In this embodiment of this application, a point mark corresponding to a point is displayed in the first range identifier. For example, a player performs a range marking operation on a first point on the virtual map, and a point mark corresponding to the first point is displayed in a generated first range identifier. In some embodiments, the first range identifier is highlighted or flashed every preset time, to prompt the player of a position of the first range identifier on the virtual map.

In this embodiment of this application, in response to a virtual interaction organ existing at a position of the first point on the virtual map, a first identifier in a first state is displayed at the position of the first point; and in response to no virtual interaction organ existing at the position of the first point on the virtual map, a second identifier in a second state is displayed at the position of the first point. The first state and the second state are configured for indicating that at least one of display icons, display forms, display colors, display fonts, display transparency, and the like of the first identifier and the second identifier are different. For example, in response to a virtual organ being placed at the position indicated by the first point, a “house” icon is displayed at the first point; and in response to no interactive virtual organ being placed at the position indicated by the first point, a “circular point” icon is displayed at the first point.

In this application, a range marking function is provided for a player, that is, the player performs a first range marking operation on a partial region on a virtual map, to generate a first range identifier marking the partial region. Therefore, in comparison with the related technology in which only a single point is marked, the player can mark the partial region on the virtual map, where the partial region is a range mark. More battle information can be transferred through one marking operation, to improve efficiency of transferring the battle information. For example, when the player is in a special scene, the player directly transfers battle information through a range mark, so that efficiency of transferring battle information between players can be improved, thereby improving battle experience. For example, when virtual resources placed in different regions in a virtual scene are imbalanced, the player may perform range marking on a high resource region (a region including more virtual resources or virtual organs) on a virtual map, and a generated first range identifier can provide more battle information for the player, so that the player intuitively learns of a range of the high resource region by using the first range identifier, to improve a sensing capability of the player for a battle resource.

For the first range identifier mentioned in operation 301 and operation 302, the following describes a specific generation manner of the first range identifier in detail.

First case: The first range marking operation is implemented as a point trigger operation.

The point trigger operation may be implemented as any one of a click/tap operation, a double-click/tap operation, a long press operation, a voice operation, a peripheral instruction, a triple-click/tap operation, and the like.

In response to receiving the point trigger operation performed on the virtual map, the first range identifier is dynamically generated based on the triggered first point, where the position indicated by the first point is marked in the first range identifier. For example, a player performs a click/tap operation on a point a on a virtual map, and the terminal dynamically generates, based on the click/tap operation, a first range identifier in which the point a is marked. For example, the first range identifier may be an identifier centered on the first point or not centered on the first point. This is not limited in this application. A dynamically changed first range identifier is generated for the first point by using the point trigger operation, and the first range identifier covers a partial region including the first point, to overcome a technical defect of marking only one mark for the first point, and extend a markable range of the first point, so that more terrain information can be marked by using the first range identifier, thereby improving efficiency of transferring battle information between players.

The point trigger operation may be implemented as a continuous operation or may be implemented as a single click/tap operation.

(1) When the point trigger operation is implemented as the single click/tap operation, in response to receiving the click/tap operation on the first point on the virtual map, the corresponding first range identifier is generated based on the triggered first point. A marked range of the first range identifier is preset. In this case, after the first range identifier is generated, a range modification control is displayed in the target application program. The range modification control is configured to adjust the marked range of the first range identifier. For example, the range modification control includes an increase control, a reduce control, and a range value input control. In response to receiving a trigger operation on the increase control, the marked range of the first range identifier is increased; in response to receiving a trigger operation on the reduce control, the marked range of the first range identifier is reduced; and in response to receiving a trigger operation on the range value input control, a range value inputted by the player is read, and the marked range of the first range identifier is adjusted based on the range value.

(2) When the point trigger operation is implemented as the continuous operation, in response to receiving a continuous trigger operation on the first point on the virtual map, a marked range of the first range identifier is dynamically scaled, to generate the first range identifier, where the marked range indicates a marked range of the virtual map. For example, a player long presses the first point, and a dynamically changed first range identifier is generated at the first point. The player performs the continuous operation based on the point trigger operation on the first point, and a process of dynamically changing the marked range of the first range identifier is displayed on the virtual map, so that the player intuitively determines a range marked by the first range identifier, thereby improving accuracy and convenience of marking a range.

When the point trigger operation is implemented as the continuous operation, a size of the marked range of the first range identifier is related to duration of the point trigger operation. In other words, in response to receiving the continuous trigger operation on the first point on the virtual map, the marked range of the first range identifier is dynamically scaled with a change of time, to generate the first range identifier. In this embodiment of this application, when the continuous trigger operation on the first point is just received, the marked range of the first range identifier is a minimum range. As time proceeds, the marked range of the first range identifier is enlarged from the minimum range to a maximum range at a constant or variable speed. When the marked range of the first range identifier is enlarged to the maximum range, as time proceeds, the marked range of the first range identifier is scaled down from the maximum range to the minimum range at a constant or variable speed. If the point trigger operation is not ended, a process of enlarging the marked range of the first range identifier from the minimum range to the maximum range and then scaling down to the minimum range is cyclically performed. The minimum range and the maximum range are preset ranges. A change process of the marked range of the first range identifier is displayed on the virtual map in a visual manner. When a target marked range that a player intends to mark is met, only the point trigger operation needs to be stopped, without any other fine adjustment operation, so as to improve marking accuracy of a range marked by the player by using a range identifier.

For example, when the marked range of the first range identifier is implemented as a circular region, in response to receiving the continuous trigger operation on the first point on the virtual map, a radius of the marked range of the first range identifier is dynamically scaled by using the first point as a center with a change of time, to generate the first range identifier. As shown in FIG. 4, after a point trigger operation on a point 402 is received, a marked range of a first range identifier is enlarged at a constant speed by using the point 402 as a center. The marked range automatically starts to be scaled down at a constant speed when the marked range is enlarged to a marked range 401 corresponding to a maximum radius m, and the marked range restarts to be enlarged at a constant speed when the marked range is scaled down to a marked range 400 corresponding to a minimum radius n, where m is a positive number greater than n. In a continuous operation process of the point trigger operation, the marked range of the first range identifier keeps an enlarging and scaling cyclic process. In addition, the marked range of the first range identifier is a circular region, and enlarging and scaling down are for a radius of the circular region. Therefore, in this process, a player only needs to perform a continuous trigger operation on any point on a virtual map to view a marked range of a circular region of a range identifier corresponding to the point in a battle interface, so as to improve freedom and convenience of the player for range marking.

Second case: The first range marking operation is implemented as a press operation.

In response to receiving a continuous press operation on the first point on the virtual map, the terminal detects a pressing force of the press operation, and dynamically scales a coverage range of the first range identifier with a change of the pressing force, to generate the first range identifier. The pressing force is directly proportional to the coverage range. In other words, a larger pressing force indicates a larger coverage range. In this embodiment of this application, an upper limit is set for the coverage range. When the pressing force is greater than a force threshold, the coverage range of the first range identifier stops at a maximum coverage range and no longer changes. In this solution, based on the trigger operation on the first point, the marked range of the first range identifier is dynamically adjusted based on the pressing force for pressing the first point, so that a procedure of performing range marking by the player is simplified, and diversity of performing a range marking operation by the player is further enriched.

Third case: The first range marking operation is implemented as a sliding operation.

In response to receiving a sliding operation on the first point on the virtual map, a sliding track of the sliding operation is used as a contour of the first range identifier, to generate the first range identifier. In this solution, based on the trigger operation on the first point, the sliding track of the sliding operation is used as the contour of the first range identifier, to generate the marked range of the first range identifier, so that the procedure of performing range marking by the player is simplified, and the diversity of performing the range marking operation by the player is enriched.

In some embodiments, the terminal determines the contour of the first range identifier based on a start position and an end position that correspond to the sliding operation, to generate the first range identifier.

(1) In response to the start position and the end position being the same position, the sliding track corresponding to the sliding operation is considered as a closed region, and the first range identifier is generated by using the closed region as the contour of the first range identifier, where a marked region of the first range identifier is the closed region of the sliding track.

(2) In response to the start position and the end position being not the same position, the sliding track corresponding to the sliding operation is considered as a non-closed region, and the terminal completes a connection line between the start position and the end position based on a track trend of the sliding track to form a closed region, and uses the closed region as the contour of the first range identifier to generate the first range identifier, where the track trend is configured for indicating a curve direction of the sliding track. Alternatively, the terminal directly connects the start position and the end position to form a closed region, and uses the closed region as the contour of the first range identifier to generate the first range identifier.

FIG. 5 is a schematic diagram of generating a first range identifier by using a sliding operation. As shown in 50a in FIG. 5, if a start position 500 and an end position 500 of the sliding operation are the same position, a first range identifier is generated by using a sliding track 501 corresponding to the sliding operation as a contour. As shown in 50b in FIG. 5, if a start position 502 and an end position 503 of the sliding operation are not the same position, the start position 502 and the end position 503 are directly connected, and the first range identifier is generated by using a connected sliding track 504 as a contour. As shown in 50c in FIG. 5, if a start position 505 and an end position 506 of the sliding operation are not the same position, the start position 505 and the end position 506 are adaptively connected according to a track trend of a sliding track 507, and the first range identifier is generated by using a connected sliding track 507 as a contour.

Fourth case: The first range marking operation is implemented as a hover operation.

In response to receiving a hover operation on the first point on the virtual map, the marked range of the first range identifier is dynamically scaled with a change of a distance between the hover operation and the terminal, to generate the first range identifier. The distance is directly proportional to the marked range. In other words, a larger distance indicates a larger marked range. In this embodiment of this application, an upper limit is set for the marked range. When the distance is greater than a distance threshold, the marked range of the first range identifier stops at a maximum marked range and no longer changes. The diversity of performing the range marking operation by the player is enriched in this manner.

The first range identifier may also be dynamically generated by using another continuous trigger operation. This is not limited in this application.

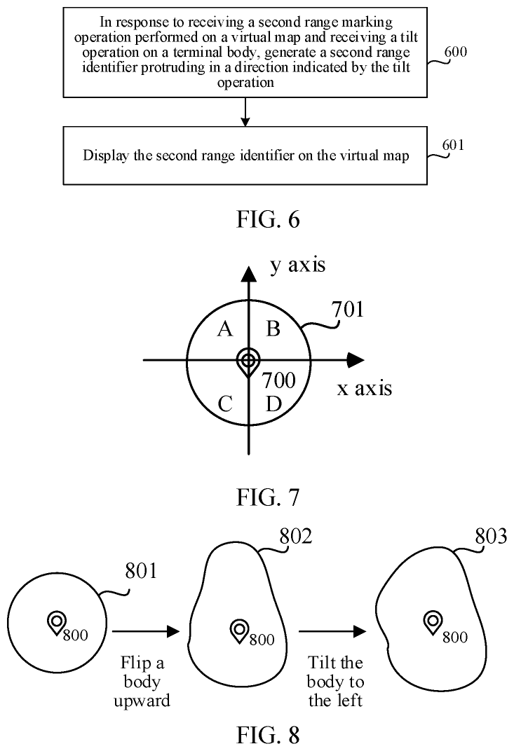

Generation of the first range identifier is described with reference to the foregoing embodiments, and a method for adjusting the marked range of the first range identifier is described in detail below. FIG. 6 is a flowchart of a virtual map marking method according to an embodiment of this application. The method is performed by a terminal.

Operation 600: Generate, in response to receiving a second range marking operation performed on a virtual map and receiving a tilt operation on a terminal body, a second range identifier protruding in a direction indicated by the tilt operation.

In some embodiments, the second range marking operation is an operation of marking a partial region on the virtual map.

The partial region on the virtual map is marked in the second range identifier.

When receiving the second range marking operation, the terminal detects whether the terminal body is tilted. The terminal detects, by using a gyroscope assembly (an angular velocity sensor) arranged in the terminal, whether the terminal body is tilted. The gyroscope assembly is configured to measure a rotation angular velocity of the terminal when a physical offset and a tilt are generated, and a function of applying the gyroscope assembly is provided in the target application program. In this embodiment of this application, the function is referred to as a gyroscope mechanism. The gyroscope mechanism is introduced into the target application program, so that when the target application program is used, it may be detected whether the terminal body is tilted or rotated.

In other words, while receiving the second range marking operation, the terminal detects whether the terminal or the target application program triggers the gyroscope mechanism.

When the terminal or the target application program does not trigger the gyroscope mechanism, the second range identifier is generated according to procedures of operation 300 and operation 301.

When the terminal or the target application program triggers the gyroscope mechanism, in response to receiving a point trigger operation performed on the virtual map, the second range identifier is dynamically generated based on a triggered second point. When detecting that the terminal body is tilted or rotated, the terminal receives the tilt operation, and generates the second range identifier protruding in the direction indicated by the tilt operation.

In this embodiment of this application, the gyroscope mechanism is introduced. When a range marking operation is performed, a marked range of a range identifier is adjusted with reference to a tilt angle of the terminal body, to meet an operation requirement of more free and abundant range marking, and achieve an objective of irregular range marking. The procedure of performing range marking by the player is simplified, and the diversity of performing the range marking operation by the player is further enriched.

A case in which when the second range marking operation and the tilt operation are simultaneously received, the second range identifier is adjusted includes at least one of the following manners.

First manner: In response to receiving the second range marking operation performed on the virtual map and receiving a first tilt operation on the terminal body in a counter-clockwise rolling direction to cause a right side of the terminal body to be higher than a left side of the terminal body, the second range identifier protruding to the left side is generated.

Second manner: In response to receiving the second range marking operation performed on the virtual map and receiving a second tilt operation on the terminal body in a clockwise rolling direction to cause the left side of the terminal body to be higher than the right side of the terminal body, the second range identifier protruding to the right side is generated.

Third manner: In response to receiving the second range marking operation performed on the virtual map and receiving a third tilt operation on the terminal body in a pitching upward direction, the second range identifier protruding to a lower side is generated. Under the third tilt operation, an upper side of the terminal body is closer to a user.

Fourth manner: In response to receiving the second range marking operation performed on the virtual map and receiving a fourth tilt operation on the terminal body in a pitching downward direction, the second range identifier protruding to an upper side is generated. Under the fourth tilt operation, a lower side of the terminal body is closer to the user.

A center of the terminal body is used as an origin of a coordinate system, a transverse direction of the terminal body is used as a horizontal axis, that is, corresponding to an x axis, and a longitudinal direction of the terminal body is used as a vertical axis, that is, corresponding to a y axis. The foregoing four cases correspond to changes of the terminal body on four axes in the coordinate system. The first case corresponds to a change of a negative axis (a left side of the origin) of the x axis in the coordinate system. The second case corresponds to a change of a positive axis (a right side of the origin) of the x axis in the coordinate system. The third case corresponds to a change of a negative axis (a lower side of the origin) of the y axis in the coordinate system. The fourth case corresponds to a change of a positive axis (an upper side of the origin) of the y axis in the coordinate system. As shown in FIG. 7, when a second range marking operation on a second point 700 is received, a second range identifier 701 corresponding to the second point 700 is generated. A coordinate system is established by using the second point 700 as a center, where a transverse direction of the second point 700 is used an x axis, and a longitudinal direction of the second point 700 is used as a y axis. The coordinate system is divided into four quadrants, namely, a quadrant A, a quadrant B, a quadrant C, and a quadrant D.

Tilt angles on the x axis and the y axis are detected when the second range marking operation on the second point is received. A marked range of the second range identifier is adjusted according to a first tilt angle on the x axis and a second tilt angle on the y axis.

A case in which tilting occurring on the x axis is used for description. In response to the first tilt angle corresponding to the x axis being positive, which means that the right side of the terminal body is higher than the left side of the terminal body, a contour of the second range identifier in the quadrant A and the quadrant C is extended outward according to the first tilt angle. For an extension distance, in an x-axis direction, of a stroke anchor included in the contour of the second range identifier in the quadrant A and the quadrant C, refer to the following formula 1. As shown in FIG. 7, the terminal body tilts on the x axis, the first tilt angle is +1°, and the stroke anchor of the quadrant A and the quadrant C is extended by a distance q in the x-axis direction, where q is calculated according to the formula 1. In response to the first tilt angle corresponding to the x axis being negative, which means that the left side of the terminal body is higher than the right side of the terminal body, a contour of the second range identifier in the quadrant B and the quadrant D is extended outward according to the first tilt angle. For an extension distance, in the x-axis direction, of a stroke anchor included in the contour of the second range identifier in the quadrant B and the quadrant D, refer to the following formula 1.

$$x = \frac{( max - min )}{90 ° - h} . \qquad Formula 1$$

In the formula 1, max is configured for indicating a maximum tilt angle of the terminal body, min is configured for indicating a minimum tilt angle of the terminal body, h is the first tilt angle, and x is an extension distance on the x axis.

A case in which tilting occurring on the y axis is used for description. In response to the second tilt angle corresponding to the y axis being positive, which means that an upward flipping operation is performed on the terminal body, a contour of the second range identifier in the quadrant A and the quadrant B is extended outward according to the second tilt angle. For an extension distance, in a y-axis direction, of the stroke anchor included in the contour of the second range identifier in the quadrant A and the quadrant B, refer to the following formula 2. As shown in FIG. 7, the terminal body tilts on the y axis, the second tilt angle is +1°, and the stroke anchor of the quadrant A and the quadrant B is extended by a distance w in the y-axis direction, where w is calculated according to the formula 2. In response to the second tilt angle corresponding to the y axis being negative, which means that a downward flipping operation is performed on the terminal body, a contour of the second range identifier in the quadrant C and the quadrant D is extended outward according to the second tilt angle. For an extension distance, in the y-axis direction, of the stroke anchor included in the contour of the second range identifier in the quadrant C and the quadrant D, refer to the following formula 2.

$$y = \frac{( max - min )}{90 ° - k} . \qquad Formula 2$$

In the formula 2, max is configured for indicating a maximum tilt angle of the terminal body, min is configured for indicating a minimum tilt angle of the terminal body, k is the second tilt angle, and y is an extension distance on the y axis.

In an actual application process, the terminal body may run on both the x axis and the y axis, and x and y are dynamic values that change in real time. The terminal adjusts extension distances of all stroke anchors of the contour of the second range identifier based on the detected first tilt angle and second tilt angle, and generates an adjusted second range identifier according to all extended stroke anchors.

There are upper limits on a x value change caused by the first tilt angle and a y value change caused by the second tilt angle. In this embodiment of this application, when the first tilt angle and the second tilt angle both exceed 90°, a maximum limit is reached, and the marked range corresponding to the second range identifier is not adjusted any more.

Operation 601: Display the second range identifier on the virtual map.

In some embodiments, a process of dynamically adjusting the second range identifier according to the tilt operation shown in operation 600 is displayed on the virtual map, so that a player can intuitively view, on the virtual map, a change process of the marked range corresponding to the second range identifier.

In some embodiments, in response to receiving the second range marking operation on the second point, the second range identifier and a second identifier corresponding to the second point are generated.

FIG. 8 is a schematic diagram of an interface of dynamically adjusting a second range identifier according to a tilt angle of a terminal body. The terminal receives a first range marking operation on a first point 800 on a virtual map, to generate a first range identifier 801. In a process of performing a continuous trigger operation on the first point 800, a player flips the terminal body upward, and an upper region of the first range identifier 801 is extended outward, to form a new first range identifier 802; and the player continues to deflect the terminal body to the left to cause a right side of the terminal body to be higher than a left side of the terminal body, and a left region of the new first range identifier 802 is extended outward, to form a new first range identifier 803.

In this embodiment of this application, a gyroscope mechanism is introduced. When a range marking operation is performed, a marked range of a range identifier is adjusted with reference to a tilt angle of a terminal body. In addition, a protruding range identifier is generated in different directions for different tilt operations, and a plurality of tilt operations can be further combined, to meet an operation requirement of more free and abundant range marking, thereby achieving an objective of a plurality of irregular range marking.

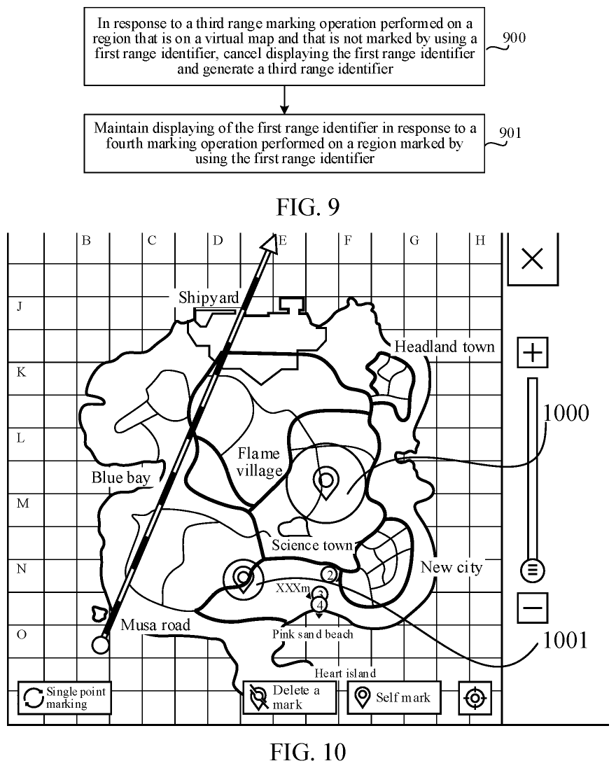

The following describes a method for modifying a range identifier in detail. FIG. 9 is a flowchart of a virtual map marking method according another embodiment of this application. The method is performed by a terminal.

Operation 900: In response to receiving a third range marking operation performed on a region that is on a virtual map and that is not marked by using a first range identifier, cancel displaying the first range identifier and generate a third range identifier.

In this embodiment, a position indicated by a first point and a first identifier corresponding to the first point are marked in the first range identifier. In some embodiments, a display center of the first range identifier may be the first point, or may not be the first point. This is not limited in this application.

When a player needs to update a range identifier, the player performs a range marking operation on a point other than the first point on the virtual map.

In other words, when the third range marking operation performed on any point in the region that is on the virtual map and that is not marked by using the first range identifier is received, display transparency and/or display brightness of the first range identifier are/is adjusted, and the third range identifier is generated and displayed on the virtual map. The display transparency and/or the display brightness of the third range identifier are/is higher than display transparency and/or display brightness of the first range identifier. For generation and display of the third range identifier, refer to operation 301 and operation 302, and details are not described herein again. In this solution, a plurality of range identifiers marked by the player are displayed on the virtual map. To save display resources, an upper limit is set for a quantity of the plurality of range identifiers that exist simultaneously. For example, at most five range identifiers can be simultaneously displayed on the virtual map, and when a 6th range identifier appears, displaying of an initially marked range identifier is canceled. As shown in FIG. 10, a player marks a first range identifier 1000 on a virtual map for a first point in advance. When the player again performs range marking on a region outside a range marked by using the first range identifier 1000, a second range identifier 1001 is generated, and display transparency of the first range identifier 1000 is reduced.

When the third range marking operation performed on any point in the region that is on the virtual map and that is not marked by using the first range identifier is received, the first range identifier corresponding to the first point is moved to a third point and is displayed as a third range identifier. Specifically, a marked range of the third range identifier corresponding to the third point is determined. When the marked range of the third range identifier is greater than a marked range of the first range identifier, the first range identifier corresponding to the first point is first moved to the third point to cause a center of a region marked by using the first range identifier to overlap the third point, and the marked range of the first range identifier is dynamically enlarged until the marked range of the first range identifier is the same as the marked range of the third range identifier. When the marked range of the third range identifier is equal to the marked range of the first range identifier, the first range identifier corresponding to the first point is moved to the third point to cause a center of a region marked by using the first range identifier to overlap the third point. When the marked range of the third range identifier is less than the marked range of the first range identifier, the first range identifier corresponding to the first point is first moved to the third point to cause a center of a region marked by using the first range identifier to overlap the third point, and the marked range of the first range identifier is dynamically scaled down until the marked range of the first range identifier is the same as the marked range of the third range identifier. As shown in FIG. 10, the player marks the first range identifier 1000 on the virtual map for the first point in advance. When the player again performs range marking (a second point) on the region outside the range marked by using the first range identifier 1000, the second range identifier 1001 is generated, an animation that a center of a marked region of the first range identifier 1000 is moved to a position of the second point is displayed, and the first range identifier 1000 is scaled down according to a display radius of the second range identifier 1001 until a display radius of the first range identifier 1000 is the same as the display radius of the second range identifier 1001.

In response to receiving a drag operation on the first range identifier, the first range identifier may be used as a range identifier of another point, and a new range mark is formed on the virtual map. After the drag operation ends, the terminal displays a mark corresponding to a center of the dragged first range identifier and cancels displaying a first mark at the first point. For example, after the first range identifier is dragged, a new range mark is formed, a center of the new range mark is a fourth point, and the terminal cancels displaying the first mark, and automatically displays a corresponding second mark at the fourth point.

When the third range marking operation performed on any point in the region that is on the virtual map and that is not marked by using the first range identifier is received, displaying of the first range identifier is canceled, the third range identifier is generated according to procedures of operation 301 and operation 302, and the third range identifier is displayed on the virtual map.

In any one of the foregoing manners, when the player needs to modify a range mark or adjust the range mark, a procedure of remarking by the player can be reduced, and range marking efficiency is improved to a certain extent.

Operation 901: Maintain displaying of the first range identifier in response to receiving a fourth marking operation performed on a region marked by using the first range identifier.

If the player needs to remark only the first range identifier, a process of generating the range identifier does not need to be performed again, and displaying of the first range identifier is maintained. In addition, displaying of the first mark corresponding to the first point is canceled, and a third mark corresponding to a fifth point is regenerated according to the fifth point triggered by using the fourth marking operation.

In this embodiment of this application, after the range identifier is generated, virtual organs, virtual resources, enemy virtual objects, and the like that can interact with each other within the range identifier are highlighted.

In other words, the first range identifier is displayed on the virtual map, and a virtual organ within the first range identifier is highlighted. The virtual organ is configured to interact with a virtual object in a virtual scene, for example, a virtual shop, a virtual task point, or a virtual plot trigger point. The player conveniently and intuitively learns of resources in the virtual scene, and a strong prompt function is provided for the player through highlighting, to improve an information obtaining capability of the player for battle scene information.

The first range identifier is displayed on the virtual map, and the virtual resource within the first range identifier is highlighted.

The first range identifier is displayed on the virtual map, and an enemy virtual object or an artificial intelligence (AI) virtual object within the first range identifier is highlighted.

In this embodiment of this application, a deletion control is displayed on an interface of the target application program, and the deletion control is configured to clear a mark on the virtual map. In response to receiving a trigger operation on the deletion control, all marks on the virtual map are cleared, where the marks include a mark for a single point and a range identifier. All marks on a virtual map of a terminal of another player in the same camp may also be synchronously cleared. Alternatively, in response to receiving a trigger operation on the deletion control, a mark previously performed on the virtual map is cleared; or in response to receiving a trigger operation on the deletion control, a mark initially performed on the virtual map is cleared.

In this embodiment of this application, when a player needs to modify a range identifier or adjust a range identifier, a more diversified range identifier adjustment manner is provided for the player, thereby improving a sense of experience of the player during range marking and improving efficiency of performing range marking by the player.

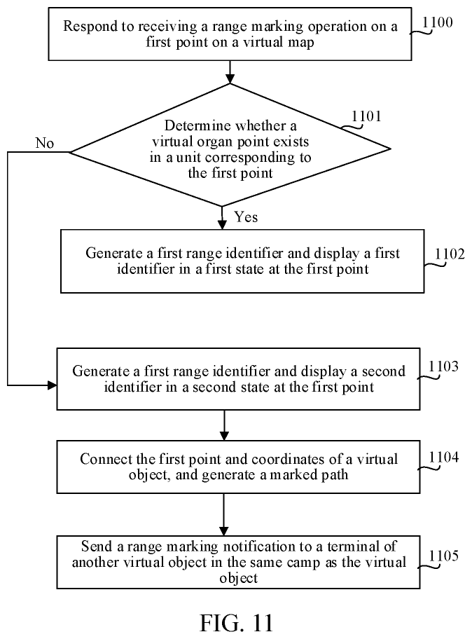

FIG. 11 is a flowchart of a virtual map marking method according to still another embodiment of this application. The method is performed by a terminal.

Operation 1100: Respond to receiving a range marking operation on a first point on a virtual map.

A procedure of this operation is the same as a procedure of operation 301, and details are not described herein again.

Operation 1101: Determine whether a virtual organ point exists in a unit corresponding to the first point.

In this embodiment of this application, a land unit of a preset area is set in a virtual scene, and each organ point, terrain structure, and the like required in the virtual scene are placed in the land unit.

After the range marking operation on the first point is received, a first unit of the first point is obtained, and it is determined whether the virtual organ point exists in the first unit.

If the virtual organ point exists in the first unit, operation 1102 is performed. If the virtual organ point does not exist in the first unit, operation 1103 is performed.

Operation 1102: Generate a first range identifier and display a first identifier in a first state at the first point.

In this embodiment of this application, to better prompt a player of an attribute or a function of a marking point, virtual resources or virtual organs that exist near the marking point are displayed by using different identifiers, so that the player directly learns, from the mark identifier, whether to continue to head to the marking point. For example, different mark identifiers are set for different virtual organ points.

Operation 1103: Generate a first range identifier and display a second identifier in a second state at the first point.

In this embodiment of this application, the first state and the second state are configured for indicating that at least one of display sizes, display icons, display text, and the like of the first identifier and the second identifier are different.

Operation 1104: Connect the first point and coordinates of a virtual object, and generate a marked path.

After the first range identifier corresponding to the first point is generated, coordinates of a position of the virtual object are obtained, and the first point is connected to the coordinates in a manner such as a dashed line/a straight line/a dash-point line/a wavy line on the virtual map, to generate the marked path. The marked path is a path for prompting the player to control the virtual object to go to the first point.

Operation 1105: Send a range marking notification to a terminal of another virtual object in the same camp as the virtual object.

The range marking notification is configured for prompting another player that the player in the same camp has performed a range marking operation on the virtual map, and synchronously displaying the first range identifier on a virtual map displayed on the terminal of the another player in the same camp.

In this embodiment of this application, a range marking function is provided for the player, and a defect that only one point can be marked at a time in the related technology is resolved. In addition, marks of points in a range identifier can be displayed in different state, thereby greatly improving a sensing capability of the player for battle resources, and improving efficiency of transferring battle information between players.

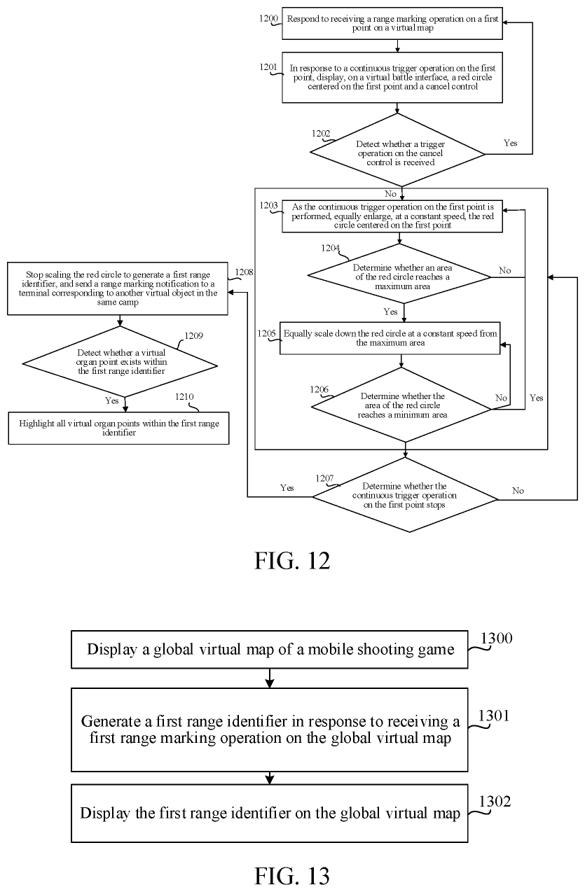

With reference to the foregoing embodiments, the following provides a complete embodiment of a virtual map marking method. FIG. 12 is a flowchart of a virtual map marking method according to still another embodiment of this application. The method is performed by a terminal.

Operation 1200: Respond to receiving a range marking operation on a first point on a virtual map.

A procedure of this operation is the same as a procedure of operation 301, and details are not described herein again.

Operation 1201: In response to a continuous trigger operation on the first point, display, on a virtual battle interface, a red circle centered on the first point and a cancel control.

In this embodiment of this application, when the continuous trigger operation on the first point is received, the cancel control is displayed in the interface, and the red circle is displayed at the first point.

In some embodiments, the cancel control is configured to indicate to cancel the range marking operation on the first point.

Operation 1202: Detect whether a trigger operation on the cancel control is received.

When the trigger operation on the cancel control is detected, operation 1200 is performed; or if the trigger operation on the cancel control is not detected, the following operation 1203 is performed.

Operation 1203: As the continuous trigger operation on the first point is performed, equally enlarge, at a constant speed, the red circle centered on the first point.

In some embodiments, when a player keeps performing a trigger operation on the first point, the red circle at the first point is enlarged by using the first point as a center, to enlarge a marked range of a first range identifier corresponding to the first point.

Operation 1204: Determine whether an area of the red circle reaches a maximum area.

If the area (a marked area) of the red circle reaches a preset maximum area, operation 1205 is performed; or if the area of the red circle does not reach a preset maximum area, operation 1203 is performed.

Operation 1205: Equally scale down the red circle at a constant speed from the maximum area.

Operation 1206: Determine whether the area of the red circle reaches a minimum area.

If the area (the marked area) of the red circle reaches a preset minimum area, operation 1203 is performed; or if the area of the red circle does not reach a preset minimum area, operation 1205 is performed.

In a process of performing operation 1203 to operation 1206, the continuous trigger operation on the first point is not canceled or does not stop.

Operation 1207: Determine whether the continuous trigger operation on the first point stops.

If the continuous trigger operation on the first point stops, operation 1208 is performed; or if the continuous trigger operation on the first point does not stop, operation 1203 to operation 1206 are cyclically performed.

Operation 1208: Stop scaling the red circle to generate the first range identifier, and send a range marking notification to a terminal corresponding to another virtual object in the same camp.

In some embodiments, when the player stops the trigger operation on the first point, a display area of the red circle corresponding to a stop moment is used as a marked area of the first range identifier and is displayed on the virtual map.

In addition, the range marking notification is sent to the terminal corresponding to the another virtual object in the same camp, and the range marking notification is configured for prompting a teammate that a new range mark is marked on the virtual map.

Operation 1209: Detect whether a virtual organ point exists within the first range identifier.

In some embodiments, it is detected whether the virtual organ point exists within the first range identifier. If the virtual organ point exists within the first range identifier, operation 1210 is performed; or if the virtual organ point does not exist within the first range identifier, a normal marked range of the first range identifier is displayed on the virtual map.

Operation 1210: Highlight all virtual organ points within the first range identifier.

An execution procedure of this operation is the same as the execution procedure of operation 901, and details are not described herein again.

In this embodiment of this application, a range marking requirement is provided for a player, so that an objective of range marking can be independently achieved, and the player can generate a range identifier under a continuous trigger operation on a point, to avoid frequent marking of a plurality of points by the player within the same range. In addition, marks in different states are displayed depending on whether a virtual organ point exists in a unit of a triggered point, to prompt the player of a battle value of the point, so that the player better and faster performs a battle. Moreover, all virtual organ points within a range identifier are highlighted, to provide a strong prompt function for the player, so that the player receives battle information more intuitively, thereby improving efficiency of transferring the battle information between the player and another player according to a state of a mark within the range identifier.

The following provides a specific method flowchart when a virtual map marking method is applied to in a mobile shooting game. As shown in FIG. 13, the method includes operation 1300 to operation 1302, and the method is performed by a terminal.

Operation 1300: Display a global virtual map of the mobile shooting game.

In some embodiments, a player opens a shooting game on a terminal, and the global virtual map is displayed in a battle interface of the shooting game. In some embodiments, a thumbnail virtual map is displayed in the battle interface, and a global map control arranged around the thumbnail virtual map is tapped, to view the global virtual map.

In some embodiments, the global virtual map is configured for displaying terrain information in a virtual scene corresponding to the shooting game, and a plurality of organ points, a plurality of virtual buildings, a plurality of virtual supplies, and the like are set in the virtual scene. In this embodiment of this application, all resources included in the virtual scene are displayed on the global virtual map by using different identifiers.

Operation 1301: Generate a first range identifier in response to receiving a first range marking operation on the global virtual map.

The first range marking operation is an operation of marking a partial region on the global virtual map.

The first range marking operation may be performed based on a point trigger, or may be performed based on a continuous trigger operation on a point. In other words, in response to receiving a point trigger operation on the global virtual map, the first range identifier is displayed at a first point. Alternatively, in response to receiving a point trigger operation on the global virtual map, the first range identifier is dynamically generated based on a triggered first point, where a position indicated by the first point is marked in the first range identifier.

In some embodiments, in response to receiving a continuous trigger operation on the first point, as time proceeds, a marked range of the first range identifier is dynamically scaled, to generate the first range identifier, where the marked range is a range of the global virtual map marked by using the first range identifier.

In an embodiment, when the marked range is implemented as a circular region, in response to receiving the continuous trigger operation on the first point on the virtual map, as time proceeds, a radius of the marked range of the first range identifier is dynamically scaled by using the first point as a center, to generate the first range identifier.

In response to canceling or stopping the continuous trigger operation on the first point, a marked range corresponding to a moment at which the continuous trigger operation is canceled is determined as the first range identifier.

In another embodiment, in response to receiving a sliding operation on the first point on the global virtual map, a sliding track of the sliding operation is used as a contour of the first range identifier, to generate the first range identifier.

In another embodiment, in response to receiving a second range marking operation on the global virtual map and receiving a tilt operation on a terminal body, a second range identifier protruding in a direction indicated by the tilt operation is generated, where a partial region on the global virtual map is marked in the second range identifier.

A process of dynamically adjusting the second range identifier when the tilt operation on the terminal body is received includes at least one of the following.

In response to receiving the second range marking operation on the global virtual map and receiving a first tilt operation on the terminal body in a counter-clockwise rolling direction to cause a right side of the terminal body to be higher than a left side of the terminal body, the second range identifier protruding to the left side is generated.

In response to receiving the second range marking operation on the global virtual map and receiving a second tilt operation on the terminal body in a clockwise rolling direction to cause the left side of the terminal body to be higher than the right side of the terminal body, the second range identifier protruding to the right side is generated.

In response to receiving the second range mark operation on the global virtual map and receiving a third tilt operation on the terminal body in a pitching upward direction, the second range identifier protruding to a lower side is generated, where the third tilt operation means flipping the terminal body downward to cause an upper side of the terminal body to be closer to a player.

In response to receiving the second range mark operation on the global virtual map and receiving a fourth tilt operation on the terminal body in a pitching downward direction, the second range identifier protruding to the upper side is generated, where the fourth tilt operation means flipping the terminal body upward to cause the lower side of the terminal body to be closer to the player.

In some embodiments, when range marking needs to be performed on the global virtual map again, it is determined whether a newly triggered second point falls within the marked range of the first range identifier.

If the second point falls within the marked range of the first range identifier, the first range identifier is kept unchanged, displaying of a first mark corresponding to the first point is cancelled, and a second mark at the second point is displayed; or display brightness/transparency of the first mark at the first point is reduced, and the second mark at the second point is displayed; or the first mark corresponding to the first point is continuously displayed, and the second mark corresponding to the second point is highlighted.

If the second point does not fall within the marked range of the first range identifier, that is, in response to receiving a third range marking operation on a region that is on the global virtual map and that is not marked by using the first range identifier, displaying of the first range identifier is canceled, and a third range identifier is generated.

In this embodiment of this application, after a range identifier is generated on a virtual map, a range marking notification, for example, a voice broadcast of “User aa newly marks a new range point”, is broadcast on a terminal of a player performing range marking and a terminal corresponding to a player in the same camp as the player.

Based on all the range identifiers generated in the foregoing procedure, it is detected whether virtual organs, virtual resources, enemy virtual objects, or the like exists in regions marked by using the range identifiers. If the virtual organs, the virtual resources, the enemy virtual objects, or the like exist in the regions marked by using the range identifiers, display identifiers corresponding to the virtual organs, the virtual resources, the enemy virtual objects, or the like in the range identifiers are highlighted.

Operation 1302: Display the first range identifier on the global virtual map.

In some embodiments, a process of dynamically generating or dynamically adjusting the first range identifier shown in operation 1301 is displayed on the global virtual map. In other words, a change process of the marked range corresponding to the first range identifier can be intuitively viewed on the global virtual map.

In this embodiment of this application, in a mobile shooting game, a range marking function is provided for a player, so that the player can mark a range region on a global virtual map, and conveniently adjust a size and a shape of the range region with reference to a plurality of operation manners. This helps the player accurately transfer battle information such as a virtual material region, a forwarding route, and a forwarding direction to a teammate, so that the player communicates better with each other by using the range identifier with muting a microphone, thereby improving efficiency of marking the virtual map and improving efficiency of transferring battle information between players.

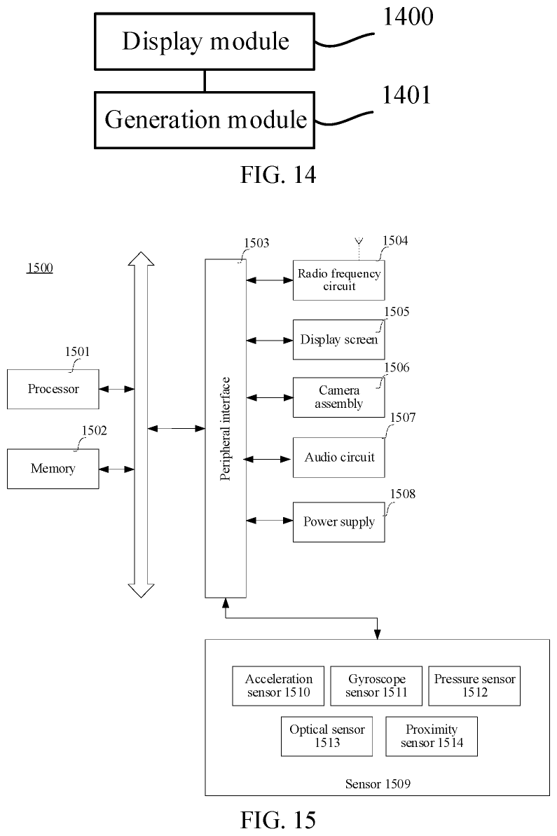

FIG. 14 is a structural block diagram of a virtual map marking apparatus according to an embodiment of this application. The apparatus includes:
a display module 1400, configured to display a virtual map, where the virtual map is configured for describing terrain information of a virtual scene in a battle; and
a generation module 1401, configured to generate a first range identifier in response to receiving a first range marking operation performed on the virtual map, where the first range identifier marks partial regions on the virtual map; and
the display module 1400 is further configured to display the first range identifier on the virtual map.

In some embodiments, the generation module 1401 is further configured to: in response to receiving a point trigger operation performed on the virtual map, dynamically generate the first range identifier based on a triggered first point, where the first range identifier is marked with a position indicated by the first point.

In some embodiments, the generation module 1401 is further configured to: in response to receiving a continuous trigger operation at the first point on the virtual map, dynamically scale a marked range of the first range identifier, to generate the first range identifier, where the marked range indicates a marked range of the virtual map.

In some embodiments, the generation module 1401 is further configured to: in response to receiving a continuous trigger operation on the first point on the virtual map, dynamically scale the marked range of the first range identifier with a change of time, to generate the first range identifier.

In some embodiments, the marked range is a circular area; and the generation module 1401 is further configured to: in response to receiving the continuous trigger operation at the first point on the virtual map, dynamically scale a radius of the marked range of the first range identifier centered on the first point with a change of time, to generate the first range identifier.

In some embodiments, the generation module 1401 is further configured to: in response to the virtual map receiving a continuous press operation at the first point, dynamically scale a coverage range of the first range identifier with a change of a pressing force, to generate the first range identifier.

In some embodiments, the generation module 1401 is further configured to: in response to receiving a continuous press operation at the first point on the virtual map, dynamically scale the marked range of the first range identifier with a change of a pressing force, to generate the first range identifier.

In some embodiments, the generation module 1401 is further configured to: in response to receiving a second range marking operation performed on the virtual map and receiving a tilt operation on a terminal body, generate a second range identifier protruding in a direction indicated by the tilt operation, where the second range identifier marks partial regions on the virtual map.

The second range identifier is displayed on the virtual map.

In some embodiments, the generation module 1401 is further configured to: in response to receiving the second range marking operation performed on the virtual map and receiving a first tilt operation on the terminal body in a counter-clockwise rolling direction to cause a right side of the terminal body to be higher than a left side of the terminal body, generate a second range identifier protruding to the left side.

The generation module 1401 is further configured to: in response to receiving the second range marking operation performed on the virtual map and receiving a second tilt operation on the terminal in a clockwise rolling direction to cause the left side of the terminal body to be higher than the right side of the terminal body, generate a second range identifier protruding to the right side.

The generation module 1401 is further configured to: in response to receiving the second range marking operation performed on the virtual map and receiving a third tilt operation on the terminal body in a pitching upward direction, generate a second range identifier protruding to the down side, where the third tilt operation is an operation of flipping the terminal body downward.

The generation module 1401 is further configured to: in response to receiving the second range marking operation performed on the virtual map and receiving a fourth tilt operation on the terminal body in a pitching downward direction, generate a second range identifier protruding to the upper side, where the fourth tilt operation is an operation of flipping the terminal body upward.

In some embodiments, the display module 1400 is further configured to: in response to receiving a third range marking operation performed on an area on the virtual map that is not marked by the first range identifier, cancel displaying the first range identifier and generate the third range identifier, where the third range identifier marks partial regions on the virtual map.

In some embodiments, the display module 1400 is further configured to highlight a virtual organ within the first range identifier, where the virtual organ is configured to interact with a virtual object in a virtual scene, and the virtual object is a movable object in the virtual scene.

The virtual map marking apparatus provided in this application provides a range marking function for the player when the player marks the virtual map. In other words, the player performs marks on an area on the virtual map, to resolve a technical defect in the related technology that only points are marked. When the player is in a special scene, battle information is directly transferred by using a range marking function, so as to improve the efficiency of transferring the battle information between players and improve the battle experience. For example, when virtual resources placed in different areas in the virtual scene are not balanced, the player may perform the range mark on a high resource area (an area including more virtual resources or virtual organs) on a virtual map, and a generated first range identifier may provide more battle information for the player, so that the player intuitively knows a range size of the high resource area by using the first range identifier, thereby improving the player's ability to sense battle resources.

The virtual map marking apparatus provided in the foregoing embodiments is only described by using division of the foregoing function modules as an example. In practical application, the foregoing functions may be allocated to and completed by different function modules according to requirements, that is, the internal structure of the apparatus is divided into different function modules, so as to complete all or part of the functions described above. In addition, the virtual map marking apparatus and the virtual map marking method provided in the foregoing embodiments fall within a same conception. For details of a specific implementation process, refer to the method embodiments. Details are not described herein may again.

FIG. 15 is a block structural diagram of a computer device 1500 according to an embodiment of this application. The computer device 1500 may be a portable mobile terminal such as a smartphone, a tablet computer, a moving picture experts group audio layer III (MP3) player, and a moving picture experts group audio layer IV (MP4) player. The computer device 1500 may also be referred to as another name such as user equipment, a portable terminal, or a head-mounted computer device.

The computer device 1500 includes a processor 1501 and a memory 1502.

The processor 1501 may include one or more processing cores, for example, a 4-core processor or an 8-core processor. The processor 1501 may be implemented in at least one hardware form of a digital signal processing (DSP), a field-programmable gate array (FPGA), or a programmable logic array (PLC). The processor 1501 may also include a main processor and a co-processor. The main processor is a processor configured to process data in an awake state, and is also referred to as a central processing unit (CPU). The co-processor is a low power processor configured to process data in a standby state. In some embodiments, the processor 1501 may be integrated with a graphics processing unit (GPU). The GPU is configured to be responsible for rendering and drawing content that needs to be displayed on a display screen. In some embodiments, the processor 1501 may further include an AI processor. The AI processor is configured to process computing operations related to machine learning.

The memory 1502 may include one or more computer-readable storage media. The computer-readable storage medium may be tangible and non-transitory. The memory 1502 may further include a high-speed random access memory and a nonvolatile memory, for example, one or more disk storage devices or flash storage devices. In some embodiments, the non-transitory computer-readable storage medium in the memory 1502 is configured to store at least one program. The at least one program is configured to be executed by the processor 1501 to implement the virtual map marking method provided in the embodiments of this application.

In some embodiments, the computer device 1500 may alternatively include a peripheral interface 1503 and at least one peripheral device. Specifically, the peripheral device includes at least one of a radio frequency circuit 1504, a display screen 1505, a camera assembly 1506, an audio circuit 1507, and a power supply 1508.

The peripheral interface 1503 may be configured to connect at least one peripheral device related to input/output (I/O) to the processor 1501 and the memory 1502. In some embodiments, the processor 1501, the memory 1502, and the peripheral interface 1503 are integrated on the same chip or circuit board. In some other embodiments, any one or two of the processor 1501, the memory 1502, and the peripheral interface 1503 may be implemented on a single chip or circuit board. This is not limited in this embodiment.

The radio frequency circuit 1504 is configured to receive and transmit a radio frequency (RF) signal, which is also referred to as an electromagnetic signal. The radio frequency circuit 1504 communicates with a communication network and another communication device by using an electromagnetic signal. The radio frequency circuit 1504 converts an electrical signal into an electromagnetic signal for transmission, or converts a received electromagnetic signal into an electrical signal. In some embodiments, the radio frequency circuit 1504 includes: an antenna system, an RF transceiver, one or more amplifiers, a tuner, an oscillator, a digital signal processor, a codec chip set, a subscriber identity module card, and the like. The radio frequency circuit 1504 may communicate with another terminal by using at least one wireless communication protocol. The wireless communication protocol includes, but is not limited to, a world wide web, a metropolitan area network, an intranet, generations of mobile communication networks (2G, 3G, 4G, and 5G), a wireless local area network, and/or a wireless fidelity (WiFi) network. In some embodiments, the radio frequency circuit 1504 may further include a circuit related to near field communication (NFC). This is not limited in this application.

The display screen 1505 is configured to display a user interface (UI). The UI may include a graph, text, an icon, a video, and any combination thereof. In some embodiments, the computer device 1500 includes an internal display screen and an external display screen that are close to eyes of a user object. The external display screen is configured to display, when a surrounding object interacts with the use object of the computer device 1500, an eye image of the use object. In some embodiments, the display screen 1505 further has an ability of acquiring a touch signal on or above a surface of the display screen 1505. The touch signal may be inputted to the processor 1501 as a control signal for processing. The display screen 1505 is configured to provide a virtual button and/or a comment keyboard, which is also referred to as a soft button and/or a soft keyboard. In some embodiments, there may be one display screen 1505, arranged on a front panel of the computer device 1500. In some other embodiments, there may be at least two display screens 1505, respectively arranged on different surfaces of the computer device 1500 or designed in a foldable shape. In still some other embodiments, the display screen 1505 may be a flexible display screen, arranged on a curved surface or a folded surface of the computer device 1500. Even, the display screen 1505 may be set to be a non-rectangular irregular figure, namely, a special-shaped screen. The display screen 1505 may be prepared by using materials such as a liquid crystal display (LCD), an organic light-emitting diode (OLED), or the like.

The camera component 1506 is configured to acquire images or videos. In some embodiments, the camera assembly 1506 includes an internal camera and an external camera. The internal camera is configured to photograph and acquire eye pose data of the user. In some embodiments, there are at least two external cameras, which are respectively any of a main camera, a depth-of-field camera, and a wide-angle camera, to achieve background blur through fusion of the main camera and the depth-of-field camera, and achieve panoramic photographing and augmented reality (AR) through fusion of the main camera and the wide-angle camera. In some embodiments, the camera component 1506 may further include a flash. The flash may be a single color temperature flash, or may be a double color temperature flash. A double color temperature flash refers to a combination of a warm light flash and a cool light flash, and may be configured for light compensation under different color temperatures.

The audio circuit 1507 is configured to provide an audio interface between the user and the computer device 1500. The audio circuit 1507 may include a microphone and a speaker. The microphone is configured to acquire acoustic waves of a user and an environment, and convert the acoustic waves into an electrical signal to input to the processor 1501 for processing, or input to the radio frequency circuit 1504 for implementing voice communication. For the purpose of stereo acquisition or noise reduction, there may be a plurality of microphones, respectively arranged at different parts of the computer device 1500. The microphone may also be an array microphone or an omni-directional acquisition type microphone. The speaker is configured to convert electrical signals from the processor 1501 or the radio frequency circuit 1504 into an acoustic wave. The speaker may be a conventional film speaker, or may be a piezoelectric ceramic speaker. When the speaker is the piezoelectric ceramic speaker, the speaker not only may convert an electrical signal into acoustic waves audible to a human being, but also may convert an electrical signal into acoustic waves inaudible to a human being, for ranging and other purposes. In some embodiments, the audio circuit 1507 may further include an earphone jack.

The power supply 1508 is configured to supply power to assemblies in the computer device 1500. The power supply 1508 may be an alternating current, a direct current, a primary battery, or a rechargeable battery. When the power supply 1508 includes a rechargeable battery, and the rechargeable battery may be a wired rechargeable battery or a wireless rechargeable battery. The wired rechargeable battery is a battery charged through a wired line, and the wireless rechargeable battery is a battery charged through a wireless coil. The rechargeable battery may further be configured to support a fast charging technology.

In some embodiments, the computer device 1500 further includes one or more sensors 1509. The one or more sensors 1509 include, but are not limited to, an acceleration sensor 1510, a gyroscope sensor 1511, a pressure sensor 1512, an optical sensor 1513, and a proximity sensor 1514.

The acceleration sensor 1510 may detect a magnitude of acceleration on three coordinate axes of a coordinate system established by the computer device 1500. For example, the acceleration sensor 1510 may be configured to detect components of a gravity acceleration on three coordinate axes. The processor 1501 may control, according to a gravity acceleration signal acquired by the acceleration sensor 1510, the display screen 1505 to display the user interface in a landscape mode or a portrait mode. The acceleration sensor 1510 may further be configured to acquire motion data of a game or a user.

The gyroscope sensor 1511 may detect a body direction and a rotation angle of the computer device 1500. The gyroscope sensor 1511 may cooperate with the acceleration sensor 1510 to acquire a three-dimensional action of a user on the computer device 1500. The processor 1501 may implement the following functions according to data acquired by the gyroscope sensor 1511: motion sensing (for example, changing the UI according to a tilt operation of the user), image stabilization during shooting, game control, and inertial navigation.

The pressure sensor 1512 may be arranged on a side frame of the computer device 1500 and/or a lower layer of the display screen 1505. When the pressure sensor 1512 is arranged on the side frame of the computer device 1500, a holding signal of the user on the computer device 1500 may be detected, and left and right hand recognition or a quick operation is performed according to the holding signal. When the pressure sensor 1512 is arranged on the lower layer of the display screen 1505, an operable control on the UI may be controlled according to a pressure operation of the user on the display screen 1505. The operable control includes at least one of a button control, a scroll-bar control, an icon control, and a menu control.

The optical sensor 1513 is configured to acquire ambient light intensity. In an embodiment, the processor 1501 may control display brightness of the display screen 1505 according to the ambient light intensity acquired by the optical sensor 1513. Specifically, when the ambient light intensity is high, the display brightness of the display screen 1505 is increased. When the ambient light intensity is low, the display brightness of the display screen 1505 is reduced. In another embodiment, the processor 1501 may further dynamically modify a photographing parameter of the camera assembly 1506 according to the ambient light intensity acquired by the optical sensor 1513.

The proximity sensor 1514, also referred to as a distance sensor, is arranged on the front of the computer device 1500. The proximity sensor 1514 is configured to acquire a distance between the user and the front of the computer device 1500. In an embodiment, when the proximity sensor 1514 detects that a distance between a surrounding object and the front of the computer device 1500 gradually becomes smaller, the processor 1501 controls the external display screen to display an eye image of the user. When the proximity sensor 1514 detects that a distance between the user and the front of the computer device 1500 gradually becomes larger, the processor 1501 controls the internal display screen to switch from the screen-on state to the screen-off state.

A person skilled in the art may understand that the structure shown in FIG. 15 constitutes no limitation on the computer device 1500, and the terminal may include more or fewer assemblies than those shown in the figure, or some assemblies may be combined, or a different assembly deployment may be used.

The embodiments of this application further provide a computer device. The computer device includes a processor and a memory, where the memory stores at least one instruction, at least one program, and a code set or an instruction set, and the at least one instruction, the at least one program, the code set or the instruction set are loaded and executed by the processor to implement the virtual map marking method according to the foregoing embodiments of this application.

The embodiments of this application further provide a computer-readable storage medium, where the computer-readable storage medium is configured to store a computer program, and the computer program is configured to be executed by a computer device to implement the foregoing virtual map marking method.

In some embodiments, the computer-readable storage medium may include: a read-only memory (ROM), a random-access memory (RAM), a solid state drive (SSD), an optical disc, or the like. The random access memory may include a resistance random access memory (ReRAM) and a dynamic random access memory (DRAM). This application provide a computer-readable storage medium. The storage medium stores at least one instruction, at least one program, and a code set or an instruction set, and the at least one instruction, the at least one program, and the code set or the instruction set are loaded and executed by the processor to implement the virtual map marking method provided in the foregoing method embodiments.

The application provide a computer program product or a computer program. The computer program product or the computer program includes at least one program, and the at least one program is stored in the computer-readable storage medium. The processor of the computer device reads the computer-readable instruction from the computer-readable storage medium, and the processor executes the computer-readable instructions, so that the computer device performs the virtual map marking method provided in the foregoing method embodiments.

The sequence numbers of the foregoing embodiments of this application are merely for description purpose but do not imply the preference among the embodiments.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like. The foregoing descriptions are merely embodiments of this application, but are not intended to limit this application. Any modification, equivalent replacement, or improvement made within the spirit and principle of this application shall fall within the protection scope of this application.

What is claimed is:

1. A virtual map marking method performed by a computer device, and the method comprising:
displaying a graphical user interface of a battle including a virtual scene and a virtual map, the virtual map being configured for describing terrain information of the virtual scene;
in response to receiving a point trigger operation on a first point in the virtual map, dynamically generating a first range identifier in the virtual map using the triggered first point, wherein a partial region including a position indicated by the first point on the virtual map is marked in the first range identifier; and
displaying the first range identifier on the virtual map.

2. The method according to claim 1, wherein the dynamically generating the first range identifier in the virtual map using the triggered first point comprises:
dynamically scaling a marked range of the first range identifier in response to receiving a continuous trigger operation on the first point on the virtual map, to generate the first range identifier.

3. The method according to claim 2, wherein the dynamically scaling a marked range of the first range identifier in response to receiving a continuous trigger operation on the first point on the virtual map, to generate the first range identifier comprises:
dynamically scaling a radius of the marked range of the first range identifier with a change of time by using the first point as a circle center in response to receiving the continuous trigger operation on the first point on the virtual map, to generate the first range identifier.

4. The method according to claim 2, wherein the dynamically scaling a marked range of the first range identifier in response to receiving a continuous trigger operation on the first point on the virtual map, to generate the first range identifier comprises:
dynamically scaling the marked range of the first range identifier with a change of a pressing force in response to receiving a continuous press operation on the first point on the virtual map, to generate the first range identifier.

5. The method according to claim 1, wherein the dynamically generating the first range identifier in the virtual map using the triggered first point comprises:
in response to receiving a sliding operation on the first point on the virtual map, using a sliding track of the sliding operation as a contour of the first range identifier.

6. The method according to claim 1, further comprising:
in response to receiving a second range marking operation performed on the virtual map by tilting the computer device in a direction, generating a second range identifier by protruding the first range identifier in the tilting direction of the computer device, a partial region of the virtual map being marked in the second range identifier; and
displaying the second range identifier on the virtual map.

7. The method according to claim 6, wherein the generating a second range identifier by protruding the first range identifier in the tilting direction of the computer device comprises at least one of the following:
in response to receiving a first tilt operation on the computer device in a counter-clockwise rolling direction, generating the second range identifier by protruding the first range identifier to the left side of the virtual map;
in response to receiving a second tilt operation on the computer device in a clockwise rolling direction, generating the second range identifier by protruding the first range identifier to the right side of the virtual map;
in response to receiving a third tilt operation on the computer device in a pitching upward direction, generating the second range identifier by protruding the first range identifier to a lower side of the virtual map; and
in response to receiving a fourth tilt operation on the computer device in a pitch downward direction, generating the second range identifier by protruding the first range identifier to an upper side of the virtual map.

8. The method according to claim 1, further comprising:
in response to receiving a third range marking operation performed on a region of the virtual map that is outside the first range identifier, replacing the first range identifier with a third range identifier, a partial region of the virtual map being marked in the third range identifier.

9. The method according to claim 1, further comprising:
highlighting a virtual organ within the first range identifier, the virtual organ being configured to interact with a virtual object in the virtual scene.

10. A computer device, comprising a processor and a memory, the memory storing at least one computer program, and the at least one computer program, when loaded and executed by the processor, causing the computer device to implement a virtual map marking method including:
displaying a graphical user interface of a battle including a virtual scene and a virtual map, the virtual map being configured for describing terrain information of the virtual scene;
in response to receiving a point trigger operation on a first point in the virtual map, dynamically generating a first range identifier in the virtual map using the triggered first point, wherein a partial region including a position indicated by the first point on the virtual map is marked in the first range identifier; and
displaying the first range identifier on the virtual map.

11. The computer device according to claim 10, wherein the dynamically generating the first range identifier in the virtual map using the triggered first point comprises:
dynamically scaling a marked range of the first range identifier in response to receiving a continuous trigger operation on the first point on the virtual map, to generate the first range identifier.

12. The computer device according to claim 11, wherein the dynamically scaling a marked range of the first range identifier in response to receiving a continuous trigger operation on the first point on the virtual map, to generate the first range identifier comprises:
dynamically scaling a radius of the marked range of the first range identifier with a change of time by using the first point as a circle center in response to receiving the continuous trigger operation on the first point on the virtual map, to generate the first range identifier.

13. The computer device according to claim 11, wherein the dynamically scaling a marked range of the first range identifier in response to receiving a continuous trigger operation on the first point on the virtual map, to generate the first range identifier comprises:
dynamically scaling the marked range of the first range identifier with a change of a pressing force in response to receiving a continuous press operation on the first point on the virtual map, to generate the first range identifier.

14. The computer device according to claim 10, wherein the dynamically generating the first range identifier in the virtual map using the triggered first point comprises:
in response to receiving a sliding operation on the first point on the virtual map, using a sliding track of the sliding operation as a contour of the first range identifier.

15. The computer device according to claim 10, wherein the method further comprises:
in response to receiving a second range marking operation performed on the virtual map by tilting the computer device in a direction, generating a second range identifier by protruding the first range identifier in the tilting direction of the computer device, a partial region of the virtual map being marked in the second range identifier; and
displaying the second range identifier on the virtual map.

16. The computer device according to claim 15, wherein the generating a second range identifier by protruding the first range identifier in the tilting direction of the computer device comprises at least one of the following:
in response to receiving a first tilt operation on the computer device in a counter-clockwise rolling direction, generating the second range identifier by protruding the first range identifier to the left side of the virtual map;
in response to receiving a second tilt operation on the computer device in a clockwise rolling direction, generating the second range identifier by protruding the first range identifier to the right side of the virtual map;
in response to receiving a third tilt operation on the computer device in a pitching upward direction, generating the second range identifier by protruding the first range identifier to a lower side of the virtual map; and
in response to receiving a fourth tilt operation on the computer device in a pitch downward direction, generating the second range identifier by protruding the first range identifier to an upper side of the virtual map.

17. The computer device according to claim 10, wherein the method further comprises:
in response to receiving a third range marking operation performed on a region of the virtual map that is outside the first range identifier, replacing the first range identifier with a third range identifier, a partial region of the virtual map being marked in the third range identifier.

18. The computer device according to claim 10, wherein the method further comprises:
highlighting a virtual organ within the first range identifier, the virtual organ being configured to interact with a virtual object in the virtual scene.

19. A non-transitory computer-readable storage medium storing at least one computer program, and the at least one computer program, when loaded and executed by a processor of a computer device, causing the computer device to implement a virtual map marking method including:
displaying a graphical user interface of a battle including a virtual scene and a virtual map, the virtual map being configured for describing terrain information of the virtual scene;
in response to receiving a point trigger operation on a first point in the virtual map, dynamically generating a first range identifier in the virtual map using the triggered first point, wherein a partial region including a position indicated by the first point on the virtual map is marked in the first range identifier; and
displaying the first range identifier on the virtual map.

20. The non-transitory computer-readable storage medium according to claim 19, wherein the dynamically generating the first range identifier in the virtual map using the triggered first point comprises:
dynamically scaling a marked range of the first range identifier in response to receiving a continuous trigger operation on the first point on the virtual map, to generate the first range identifier.
